(19) United States
(12) Patent Application Publication
(10) Pub. No.: US 2014/0282637 A1
(43) Pub. Date: Sep. 18, 2014

(54) BROADCAST PLAYBACK CONTROL APPARATUS AND METHOD OF ELECTRONIC DEVICE

(71) Applicant: Samsung Electronics Co., Ltd., Suwon-si (KR)

(72) Inventors: Jinju PARK, Anyang-si (KR); Kwangtai KIM, Suwon-si (KR); Jungsam KIM, Incheon (KR); Jihea PARK, Seoul (KR)

(73) Assignee: Samsung Electronics Co., Ltd., Suwon-si (KR)

(21) Appl. No.: 14/181,123

(22) Filed: Feb. 14, 2014

Related U.S. Application Data
(60) Provisional application No. 61/782,422, filed on Mar. 14, 2013.

(30) Foreign Application Priority Data
Sep. 3, 2013 (KR) 10-2013-0105283

(51) Int. Cl. H04N 21/472; H04N 21/482; H04N 21/45; H04N 21/258; H04N 21/431

(52) U.S. Cl. CPC H04N 21/47214; H04N 21/25891; H04N 21/4312; H04N 21/4532; H04N 21/482
USPC 725/5; 725/58; 725/40

(57) ABSTRACT

An apparatus and method for controlling display of a broadcast program for use in a system including an electronic device with a communication function and an external display device is provided. The broadcast playback control method of an electronic device includes displaying program information including a schedule registration icon, scheduling, when the schedule registration icon is selected, a broadcast program slotted to play at a broadcast time included in the program information, and controlling playback of the registered program at the broadcast time.

### CROSS-REFERENCE TO RELATED APPLICATION(S)

This application claims the benefit under 35 U.S.C. §119(e) of a U.S. Provisional application filed on Mar. 14, 2013 in the U.S. Patent and Trademark Office and assigned Ser. No. 61/782,422, and under 35 U.S.C. §119(a) of a Korean patent application filed on Sep. 3, 2013 in the Korean Intellectual Property Office and assigned Serial number 10-2013-0105283, the entire disclosure of each of which is hereby incorporated by reference.

### TECHNICAL FIELD

The present disclosure relates to an apparatus and method for controlling a display of a broadcast program in a system including an electronic device with a communication function and an external display device.

### BACKGROUND

Typically, a user selects a broadcast channel to watch a broadcast program in real time or reserves a program the user is interested in to avoid missing the program. Currently, the program may be broadcast by a broadcast station or transmitted by an Internet Protocol Television (IP TV) server. In the case of reserving a program scheduled to be broadcast, it has been irksome to check the broadcast program information and reserve the broadcast channel and broadcast time, as these steps maybe burdensome. Furthermore, when watching a broadcast program through an external display device, there has been no way of inputting or checking the information related to the corresponding program.

Accordingly there is a need for an electronic device and a display device that is capable of allowing the electronic device to reserve a broadcast program as a schedule and the user to view the reserved broadcast program through the external display device at the scheduled time.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and method for an electronic device and a display device that is capable of allowing the electronic device to reserve a broadcast program as a schedule and the user to view the reserved broadcast program through the external display device at the scheduled time.

Where reserving a program scheduled to be broadcast, it may be irksome to check the broadcast program information and reserve the broadcast channel and broadcast time. In order to solve this problem, the system including an electronic device and a display device is capable of allowing the electronic device to reserve a broadcast program as a schedule and the user to view the reserved broadcast program through the external display device at the scheduled time. The electronic device is capable of associating a predetermined application (e.g. S planner) with Video On Demand (VOD).

In the case of watching the broadcast program through the external display device, there was no way of inputting or checking the information associated with the program. In order to solve this problem, the present disclosure proposes a broadcast playback control apparatus and method that is capable of allowing the electronic device to control the external display device to display the broadcast program, receiving and storing the input of the information associated with the program, and providing the information on the program.

In accordance with an aspect of the present disclosure, a broadcast playback control method of an electronic device is provided. The broadcast playback control method includes displaying program information including a schedule registration icon, scheduling, when the schedule registration icon is selected, a broadcast program slotted to play at a broadcast time included in the program information, and controlling playback of the registered program at the broadcast time.

In accordance with another aspect of the present disclosure, a broadcast playback control method of an electronic device is provided. The broadcast playback control method includes displaying program information including a schedule registration icon and a real time playback button, scheduling, when the schedule registration icon is selected, a broadcast program slotted to play at a broadcast time included in the program information, driving, when the real time playback button is selected, an external display device, transmitting the program information to the external display device, and controlling the external display device to play the registered broadcast program.

In accordance with another aspect of the present disclosure, a broadcast program processing method of a broadcast server system is provided. The broadcast program processing method includes receiving program information on a broadcast program selected by a user from an electronic device, analyzing the received program information to check broadcast program pattern, selecting user favorite broadcast program based on the analysis result, and transmitting the broadcast information on selected broadcast program to the electronic device registering the received broadcast program as a schedule item.

In accordance with still another aspect of the present disclosure, a broadcast playback control apparatus of an electronic device is provided. The broadcast playback control apparatus includes a communication unit configured to receive a broadcast program, a display unit configured to display the program information including a schedule registration icon and a calendar for registering the broadcast program with the program information, a storage unit configured to store the program information as a scheduled item of the calendar, and a control unit configured to display the program information including the schedule registration icon, schedule, and, when the schedule registration icon is selected, the broadcast program slotted to play at a broadcast time included in the program information, and control playback of the registered program at the broadcast time.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating architecture of a broadcast program reservation and playback system including an electronic device and an external display device according to an embodiment of the present disclosure;

FIG. 2 is a block diagram illustrating a configuration of the broadcast server of FIG. 1 according to an embodiment of the present disclosure;

FIG. 3 is a block diagram illustrating the electronic device of FIG. 1 according to an embodiment of the present disclosure;

FIG. 4 is a flowchart illustrating a procedure of registering a program in a schedule and playing a program reserved in the schedule using the program information according to an embodiment of the present disclosure;

FIG. 5 is a flowchart illustrating a procedure of registering a broadcast program as a scheduled item using an electronic device presenting program information according to an embodiment of the present disclosure;

FIGS. 6A and 6B are diagram illustrating screen displays for explaining the procedure of FIG. 5 according to an embodiment of the present disclosure;

FIG. 7 is a signal flow diagram illustrating signal flows between an electronic device and a server for registering a program automatically according to an embodiment of the present disclosure;

FIG. 8 is a flowchart illustrating the automatic program registration procedure of the electronic device according to an embodiment of the present disclosure;

FIG. 9 is a flowchart illustrating a procedure of playing a program based on the information of a registered program according to an embodiment of the present disclosure;

FIG. 10 is a flowchart illustrating a broadcast program playback method of an electronic device in interoperation with an external display device according to an embodiment of the present disclosure;

FIG. 11 is a flowchart illustrating a procedure of processing, at an external device, a broadcast program or supplementary information associated with the broadcast program being played currently on the external display device according to an embodiment of the present disclosure; and

FIGS. 12A, 12B, and 12C are diagrams illustrating screen displays for explaining procedures of controlling a playback of a program, at a tablet computer or mobile phone interoperation, in interoperation with an external display device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The electronic device according to an embodiment of the present disclosure is provided with a communication function to download broadcast program information from a server and display the program information. If a program is reserved in the state that the information on the program is displayed, the electronic device executes a schedule application to registers the program as a scheduled item therewith. Once the program has been registered as a scheduled item, the electronic device controls the external display device to power on such that the external display device receives and display the broadcast program signal under the control of the electronic device.

In the state that the external display device is displaying the received broadcast program, the user may purchase or download other programs (e.g. previously broadcast program) related to the program being played back on the external display device by means of the electronic device. Also, in the state that the external display device displays the program, the electronic device may execute a note function to store a note in association with the playing program and display the information on the playing program.

In the following, the description is directed to the case where the electronic device is a mobile terminal and the external display device is a television. In the following description, the term ‘program’ denotes a broadcast program (i.e. content) and the term ‘program information’ denotes broadcast program information (e.g. Electronic Program Guide or EPG).

FIG. 1 is a block diagram illustrating architecture of a broadcast program reservation and playback system including an electronic device and an external display device according to an embodiment of the present disclosure.

Referring to FIG. 1, the system includes a broadcast server 120 providing broadcast program and program information, and the broadcast server 120 may include program providers 1211 to 121N providing the broadcast program and program information. Here, the program providers 1211 to 121n may be broadcast stations or content providers generating and providing contents. The electronic device 100 presents the program information and registers a selected program as a scheduled item and may be connected to a base station 130 through public radio communication system (e.g. LTE and WCDMA). The electronic device 100 may connect to the Internet 140 via the base station 130 or Internet Access network (e.g. Wi-Fi, WiMAX, and WiBro), and the broadcast server 120 may be connected to the Internet 140.

The broadcast server 120 stores the programs provided by the program providers 1211 to 121N and program information including details of the programs and broadcast schedule and provides the program and/or program information in response to the request from the electronic device 100.

The electronic device 100 may establish a communication link to the broadcast server 120 via the base station 130 or Internet access network connected to the Internet 140. The electronic device 100 may receive the program information transmitted by the broadcast server 120 via the base station 130 and/or the Internet 140 and displays the received information and, if a program reservation is requested in the state that the program information is presented, executes a schedule application to register the program as a scheduled item with the program information. If a program view request is input, the electronic device 100 may activate the external display device 190 and send the information necessary for watching the program (e.g. channel information) to the external display device 190. The external display device 190 may power on and tune the channel to play the broadcast signal under the control of the electronic device 100.

The electronic device 100 may be any of the devices having a radio communication unit such as mobile terminal, tablet computer, and laptop computer. Assuming that the electronic device is a mobile terminal, the mobile terminal may be configured to support at least one of cellular communication (such as Global System for Mobile communications (GSM), Code Division Multiple Access (CDMA), Long Term Evolution (LTE), LTE-Advanced (LTE-A)), Internet Protocol (IP) communication (such as Wi-Fi, WiBro, and WiMAX)), and short range wireless communication (such as Bluetooth and Near Field Communication (NFC)). The external display device 190 may be a TV.

FIG. 2 is a block diagram illustrating a configuration of the broadcast server of FIG. 1 according to an embodiment of the present disclosure. The broadcast server 120 may store the broadcast programs generated by the program providers 1211 to 121N and provide the electronic device 100 with the programs and program information.

Referring to FIG. 2, the memory 210 stores the Operating System of the broadcast server 120. The processor 200 controls the operations of the broadcast server 120 using the Operating system stored in the memory 210. The communication unit 230 may transmit the broadcast program and/or program information in response to the request from the electronic device 100 under the control of the processor 200. The communication unit 230 also may establish a connection to the program providers 1211 to 121N to receive the programs under the control of the processor 200. The database 220 may store the programs provided by the program providers 1211 to 121N.

The processor 200 of the broadcast server 120 may register the programs and program information from the program providers 1211 to 121N with the database 220. The processor 200 may integrate the program information transmitted by the program providers 1211 to 121N into one program information (e.g. EPG). The processor 200 may transmit the program and/or program information in response to the request form the electronic device 100. The program information may be the EPG.

The processor 200 may receive the program information transmitted by the electronic device 100 using the communication unit 230. The program information transmitted by the electronic device 100 may be the information on the program registered as a scheduled item, the information on the purchased program, and/or information on the program being played by the electronic device 100. The processor 200 may analyze the parameters of the received program informations to recommend the user favorite programs. The program may be classified into one of the following genres: movie, sports, entertainment, and education; and each genre may be configured with detailed parameters. For example, the movie genre may be configured with the parameters of director, star, synopsis, etc. If the program information is received from the electronic device 100, the processor 200 may check the genre and collect and analyze the user favorite pattern (i.e. viewing pattern). The processor 200 may also search for the programs matching the user's favorite pattern and send the program informations on the found programs to the electronic device 100. The program information transmitted from the broadcast server 120 to the electronic device 100 may be registered as scheduled items with the electronic device 100.

FIG. 3 is a block diagram illustrating the electronic device of FIG. 1 according to an embodiment of the present disclosure. The electronic device registers a broadcast program as a scheduled item and controls the external display device to play the registered program.

Referring to FIG. 3, the first communication unit 320 is responsible for a radio communication function with a base station and/or an internet server. The communication unit 320 may include a transmitter for up-converting the frequency of the transmission signal and amplifying the transmit power of the transmission signal and a receiver for low noise amplifying the received signal and down-converting the frequency of the received signal. The communication unit 320 also may include a modulator and a demodulator. The modulator modulates the transmission signal to output a modulation signal to the transmitter, and the demodulator demodulates the signal received by the receiver. The modulator/demodulator for the communication scheme to connect to the Internet 140 via the base station 130 may support LTE, LTE-A, WCDMA, and GSM. The modulator/demodulator for the communication scheme to connect to the Internet 140 directly may support Wi-Fi, WiBro, and WiMAX. That is, the first communication unit 320 is capable of establishing a communication link to the broadcast server 120 via the Internet 140 and, in an embodiment of the present disclosure, it is assumed that LTE (or LTE-A) and Wi-Fi communication links are used.

The second communication unit 370 may connect to the external devices to perform short range communication. The short range communication may be implemented through a wireless or wired communication link. The wireless short range communication scheme may be any of Wi-Fi, Wi-Fi direct, NFC and Bluetooth; and the wired short range communication scheme may be any of HDMI and USB communication schemes.

The control unit 300 controls overall operations of the electronic device. The control unit 300 may register a broadcast program of which program information is presented on the screen as a scheduled item using the program information and control the external display device 190 to play the broadcast program at the scheduled time.

The storage unit 310 may include a program memory for storing an Operating System of the electronic device and a data memory for storing tables associated with the operation of the electronic device and data generated in playing the program.

The display unit 330 may display currently playing content and advertisement under the control of the control unit 300. The display unit 330 may be implemented with Liquid Crystal Display (LCD) or Organic Light Emitting Diodes (OLED). The input unit 340 may be implemented with a capacitive or resistive type touch panel to generate position information on a user's touch (hereinafter, assumed as finger touch) to the control unit 300. The input unit 340 may further include an Electro Magnetic Radiation (EMR) sensor pad to detect a pen touch input and generates the corresponding input signal to the control unit 300. The display unit 330 and the input unit 340 may be integrated into a signal component.

The broadcast receiver 350 may receive the signals broadcast by the broadcast station. The sensor 360 may detect the motion and movement speed of the electronic device. The sensor may include an acceleration sensor, a geomagnetic sensor, and a position detection sensor. The electronic device 100 may further include an audio processing unit for processing voice signals generated in telephony mode under the control of the control unit 300.

Descriptions are made of a method for registering an interested program while viewing the information on the broadcast program (first embodiment) and a method for presenting the information on the playing program using a separate display device (second embodiment).

### First Embodiment

If a program reservation is requested in the state that the program information necessary for watching TV in real time, the electronic device 100 may register the program as a scheduled item in association with the schedule application (e.g. S planer) and VOD (On Demand). Typically, the video display device is capable of navigating broadcast programs using the broadcast program information (Electronic Program Guide (EPG)). The video display device is also capable of making it possible to watch the programs already aired using rebroadcast informations or VOD informations. In the following description, the terms ‘broadcast program’ and ‘program’ are interchangeably used in the same meaning; and the terms ‘program information’, information of program’, and ‘EPG’ are used interchangeably in the same meaning. The electronic device 100 may provide the information in association with the schedule application and EPG and/or VOD in real time.

The program information provision method may be executed manually or automatically. In the manual broadcast program registration method, the control unit 300 of the electronic device 100 may download the program information from the broadcast server 120 and store in the storage unit 310 and control the display unit 330 to display the program information. The program information may include the information (including broadcast date) on the programs to be broadcast (or rebroadcast) by the broadcast station (including cable and IP TV providers). If the user select a certain program information item by means of the input unit 340 in the state that the display unit 330 displays the program information, the control unit 300 executes the schedule application which checks the broadcast date (or rebroadcast date) included in the program information and registers the program as a scheduled item with a calendar (such as S-planer). In the case of the pay program, it is possible to register the program, after the program has been purchased, as a scheduled item with the scheduler application along with the playback time.

The electronic device 100 also may register the broadcast program automatically based on the program information provided by the broadcast server 120. The control unit 300 of the electronic device 100 may transmit the information on the program registered as a scheduled item to the broadcast server 120 by means of the first communication unit 320. The processor 200 of the broadcast server 120 stores the information on the program registered with the electronic device 100 as the schedule item. If the program information is received, the processor 200 may analyze the accumulated program information to check the user's favorite programs, select the program information closely associated with the received program information, and send the selected program information to the electronic device 100. The control unit 300 registers the user favorite broadcast and content information with ‘my schedule’ automatically.

If the program information is downloaded from the broadcast server, the control unit 300 may register the information on the programs associated with the program scheduled by the user with the schedule and alarms automatically. If there is the related broadcast program registered on the same date, the control unit 300 may notify the user of the related broadcast program so as to set the schedule-registered time in consideration of the program running time or broadcast time.

As described above, a program may be registered as a scheduled item by the user manually or by the broadcast server 120 automatically such that the program is played at the time registered in the schedule. If the registered time arrives, the control unit 300 may notify the user of arrival of the registered time by means of the display unit 330 and/or the audio processing unit and turns on the external display device 190 through the second communication unit 370 in response to the user request. The external display device 190 may receive and display the program registered in the schedule under the control of the control unit 300.

If there is any missing programs among the schedule-registered programs, the control unit 300 may analyze the program information and search all broadcast stations (including cable companies) for the rebroadcast and VOD of the corresponding program and registers the found result to the schedule automatically with display of an alarm. As described above, it is possible to register a broadcast schedule automatically, check the schedule on TV, and play the registered program at the scheduled time automatically, thereby maximizing the rich TV experience of the user.

FIG. 4 is a flowchart illustrating a procedure of registering a program in the schedule and playing the program reserved in the schedule using the program information according to an embodiment of the present disclosure.

Referring to FIG. 4, if a program information display request is input through the input unit 340, the control unit 300 may detect this at operation 411 and controls the display unit 340 to display the program information at operation 413. The program information displayed on the display unit 330 may include an icon for schedule registration. If the user selects the icon, the control unit 300 may detect this at operation 415 and execute the schedule application to register the program information at operation 417. If the corresponding program is a pay program, the control unit 300 may display a purchase icon along with the program information at operation 413 and, if the purchase icon is selected, the control unit may perform the purchase procedure and download and store the purchased program in the storage unit 310. If a schedule registration request is input, the control unit 300 may detect this at operation 415 and execute the schedule application to register the purchased program as a scheduled item at operation 417.

The control unit 300 may perform schedule registration using the program information and send the registered program information to the broadcast server 120 by means of the first communication unit 320. The broadcast server 120 may store the program information received from the electronic devices and analyze user preference based the accumulated program information. When the program information is received, the broadcast server 120 may sends the electronic device 100 the information on the broadcast program related closely to the received program information through Internet 140. The control unit 300 of the electronic device determines if the program information is received at operation 421 and executes the schedule application to register the corresponding program at operation 423.

If the broadcast time of the program registered by the user manually or by the broadcast server 120 automatically arrives, the control unit 300 may detects this at operation 431 and play the registered program. If it is the time of broadcasting the program, the control unit 300 may transmit the information for driving the external display device 190 and the information on the program at operation 433. The driving information may be a power-on command of the external display device 190, and the program information may be the channel information of the program. The external display device 190 is capable of receiving and playing the broadcast program registered as a scheduled item under the control of the electronic device 100. If the control unit 300 does not detect the schedule time arrival at operation 431, then perform a corresponding function at operation 435.

If the external display device 190 is not turned on at the scheduled time (i.e. if there is any mission program), the control unit 300 may check the rebroadcast schedule of the corresponding program and reregistered the program as a scheduled item again.

FIG. 5 is a flowchart illustrating a procedure of registering a broadcast program as a scheduled item using the electronic device presenting the program information according to an embodiment of the present disclosure. FIGS. 6A and 6B are diagrams illustrating screen displays for explaining the procedure of FIG. 5 according to an embodiment of the present disclosure. FIG. 6A shows the screen displays of a mobile phone, and FIG. 6B shows the screen displays of a tablet computer.

Referring to FIGS. 5, 6A, and 6B, the control unit 300 may display the program information as shown in the part 610 of FIG. 6A at operation 511. The program information displayed by the display unit 330 may be configured as shown in part 610 of FIG. 6A. Reference number 611 denotes an icon for registering program as a scheduled item (schedule icon), reference number 613 is an icon for initiating purchase transaction to make a purchase of pay program (purchase icon), and reference number 615 is an icon for indicating the broadcast type of the program. The broadcast type icon 615 may be provided with the text ‘play’ indicating the broadcast already, ‘watch now’ indicating real time broadcast, or ‘set reminder’ indicating the program to be broadcast. The schedule registration may be done with the broadcast type of set reminder. If the schedule icon 611 is selected, the control unit 300 may detect this at operation 513, executes the schedule application and display a calendar as shown in part 620 of FIG. 6A at operation 515, registers the broadcast date and time included in the program information with the calendar as a scheduled item as denoted by reference number 623 at operation 517, and display the registration result on the display unit 330. The information registered as the scheduled item may include the broadcast time and broadcast program title. Afterward, the control unit 300 may sends the broadcast server 120 the program information registered as the scheduled item by means of the first communication unit 320.

After the program has been registered, the user may check the detailed information on the registered program. That is, if the user selects the registered program information as shown in part 620 of FIG. 6A, the control unit 300 may detect the selection of the detail view option at operation 521 and control the display unit 330 to display the detailed information on the program registered as a schedule item as shown in part 630 of FIG. 6A at operation 523.

In the case that the program is the pay program, the user may select the purchase icon (VOD item) as denoted by reference number 610 of FIG. 6A. The control unit 300 may detect this at operation 531 and transmit a purchase request message by means of the first communication unit 320 at operation 533. The server selling the program performs device authentication and purchase procedure and sends the electronic device 100 the result. Here, the program sale server may be the broadcast server 120 or another server. If the purchase procedure has completed, the control unit 300 may transmit the information on the purchased program to the broadcast server 120 at operation 535. The purchased program may be played immediately or reserved to be played later. If the user selects immediate playback option, the control unit 300 may detect this at operation 537 and play the purchased program at operation 553. The control unit 300 may play the program on the electronic device 100 with the assistance of the display unit 300 or using the external display device 190 by transmitting the purchased program to the external display device through the second communication unit 370. Meanwhile, if the user selects the schedule registration option, the control unit 300 may detect this at operation 537 and execute the schedule application to display the calendar as shown in part 620 of FIG. 6A at operation 539. If the user selects a date on the calendar and inputs time, the control unit 300 may detect this at operation 541 and registers the program as a scheduled item with the presentation of the registration result at operation 543. If the user requests for the detailed information on the program at operation 521, the control unit 300 displays the detailed information on the purchased program at operation 523.

In the case that the program is the real broadcast program, the broadcast type icon 615 is changed for the ‘Watch on’ icon in FIG. 6A. If the ‘Watch on’ icon is selected by the user, the control unit 300 may detect this as the real time broadcast playback request at operation 551 and transmits a command for activating the external display device 190 and the broadcast channel information through the second communication unit 370 to play the program at operation 553. The external display device 190 powers on to tune to the broadcast channel according to the channel information and play the broadcast signal received on the channel under the control of the electronic device 100. The second communication unit 270 may be a Wi-Fi or Wi-Fi direct communication module or wired HDMI communication module.

If the electronic device 100 is a tablet or laptop computer, the display unit 300 is large as compared to the mobile phone. In this case, the program information also may be presented in a format different from that of the mobile phone. FIG. 6B shows the screen displays of a tablet computer. The program information may be displayed as shown in part 650 of FIG. 6B and, when the rebroadcast information is included, multiple broadcast dates may be presented. If the program is not broadcast yet, the broadcast type icons associated with the broadcast dates are presented as ‘set reminder’ icon. If a broadcast type icon 651 corresponding to a certain date is selected among the plural broadcast dates, the control unit 300 may execute the schedule application to register the program corresponding to the broadcast date selected on the calendar. If the program selected 661 is registered, the control unit 300 may mark the date to indicate the registered scheduled item on the calendar as denoted by reference number 663 in part 660 of FIG. 6B and disables the registered broadcast type icon 671 to block selecting again in part 670.

As shown in FIG. 5, the user is capable of registering a program as a scheduled item using the program information. Also, the electronic device 100 may register a program as a scheduled item automatically using the program information transmitted by the broadcast server 120.

FIG. 7 is a signal flow diagram illustrating signal flows between the electronic device and the server for registering a program automatically according to an embodiment of the present disclosure.

Referring to FIG. 7, if a program is registered, the electronic device 100 may transmit the program information of the registered program to the server 120 at operation 711. The broadcast server 120 may store the program information transmitted electronic device 100 accumulatively. The broadcast server 120 may analyze the program information at operation 713 and determine the viewing pattern of the user based on the analysis result at operation 715. Since the program informations on the programs viewed by the user have been accumulated, the broadcast server 120 may make a configuration on the programs related closely to the received program information at operation 717. Once the programs have been configured, the broadcast server 120 may configure the information on the configured programs at operation 719 and transmit the program information to the electronic device 100 at operation 721. The electronic device 100 may receive the program information and registers the corresponding program with the calendar at operation 723 and notify the UE of the registration of the operation.

FIG. 8 is a flowchart illustrating the automatic program registration procedure of the electronic device according to an embodiment of the present disclosure.

Referring to FIG. 8, if the program information is registered with the calendar as a scheduled item through the procedure of FIG. 5, the control unit 300 may detect this at operation 811 and send the broadcast server 120 the program information by means of the first communication unit 320 at operation 813. If the program information is received from the broadcast server 120, the control unit 300 may detect this at operation 821 and analyze the scheduled item of the broadcast program at operation 823. The control unit 300 may check whether the broadcast schedule of the broadcast program is overlapped with the program registered with the calendar at operation 825 and, if not overlapped, execute the schedule application and register the program at the corresponding date of the calendar at operation 831. Otherwise, if the broadcast program is overlapped with a registered program, the control unit 300 may notify the user of the overlap in the form of a popup at operation 827 and adjust the schedule at operation 829. If there is no response from the user, the control unit 829 may not register the corresponding program with the schedule at operation 829.

FIG. 9 is a flowchart illustrating a procedure of playing a program based on the information of the registered program according to an embodiment of the present disclosure.

Referring to FIG. 9, if the scheduled time of the registered program arrives, the control unit 300 may detect this at operation 911 and display the registered program information in the form of a popup and establish a communication link with the external display device 190 through the second communication unit 370 at operation 913. The external display device 190 and the electronic device 100 may communication through a wireless link. If brief, if scheduled time of the registered program arrives, the control unit 300 may establish a communication link with the external display device 190 and, if the communication is established normally, determine this as the playback-available state at operation 915 and thus transmit the channel information on the program registered as a scheduled item so as to play the program at operation 917. However, if at operation 915, the control unit fails to establish the communication link with the external display device 190, the control unit 300 may determine this as the playback-unavailable state and determine whether a predetermined time duration for determining as a missing program has elapsed at operation 921. If the scheduled time arrives, the control unit 300 may establish a communication link with the external display device 190 and, if the control unit 300 fails to establish the communication link, the control unit 300 may retry communication establishment repeatedly for a predetermined duration. If the predetermined time elapses, the control unit 300 may determine that a missing program has occurred at operation 921 and handles the corresponding program as a missing program at operation 923.

If the missing program occurs, the control unit 300 analyzes the corresponding program information to check whether there is any rebroadcast schedule of the program and, if so, executes the schedule application to register the program at the rebroadcast time with the calendar at operation 923. Otherwise, there is not rebroadcast schedule, the control unit 300 may cancel the registration of the corresponding broadcast program at operation 923.

The electronic device 100 may include a broadcast receiver 350. In this case, if it is impossible to establish a communication link with the external display device 190 at the scheduled time, the control unit 300 may play the registered program with the broadcast receiver 350. That is, if it is impossible to play the program using the external display device 190, the control unit 300 may check the playback availability with the broadcast receiver 350 at operation 915 and activate the broadcast receiver 350 to play the corresponding program through the display unit 330 at operation 917.

After registering the program as a scheduled item, if the schedule time arrives, the electronic device 100 may play the registered program through the external display device 190. In the state that the external display device 190 is playing a certain broadcast program, the electronic device 100 may display other video or information associated with the broadcast program being played on the external display device 190 simultaneously.

FIG. 10 is a flowchart illustrating a broadcast program playback method of an electronic device in interoperation with the external display device according to an embodiment of the present disclosure.

Referring to FIG. 10, if program information display is requested, the control unit 300 may detect this at operation 1011 and display the program information at operation 1013. Next, if a schedule registration is request, the control unit 300 may detect this at operation 1015 and execute the schedule application to register the corresponding program as a scheduled item with on the calendar at operation 1017. The control unit 300 may sends the broadcast server 120 the information on the program registered with the calendar through the first communication unit 320. Although not shown in FIG. 10, the broadcast server 120 may analyzes the program information transmitted by the electronic device 100 to check the user's viewing pattern and configures the program information of the corresponding program such that the electronic device 100 downloads the program information. The control unit 300 of the electronic device may execute the schedule application to register the program corresponding to the downloaded program information with the calendar automatically.

If the program information to be displayed is of the real time broadcast program and if the user selects the real time broadcast type icon (e.g. the program type icon 615 with the text ‘Watch ON” presented with the program information as shown in part 610 of FIG. 6A), the control unit 300 may recognize the input of requesting viewing real time broadcast program at operation 1021. The control unit 300 may establish a connection link with the external display device by means of the second communication unit 370 and send the external display device 190 a driving command and channel information at operation 1023. If the external display device 190 starts playing the registered program, the control unit 300 may perform operation associated with the program being played on the external display device 190.

If the schedule time of the registered program arrives, the control unit 300 may detect this at operation 1031 and drives the external display device 190 at operation 1023. If the schedule time of the registered program does not arrive, the control unit 300 may perform a corresponding function 1033.

FIG. 11 is a flowchart illustrating a procedure of processing, at the external device, the broadcast program or supplementary information associated with the broadcast program being played currently on the external display device according to an embodiment of the present disclosure. FIGS. 12A, 12B and 12C are diagrams illustrating screen displays for explaining the procedures of controlling the playback of a program, at a tablet computer or mobile phone interoperation, in interoperation with an external display device according to an embodiment of the present disclosure.

Referring to FIGS. 11, 12A, 12B and 12C, if it is detected that the electronic device is running in a playback mode (if ‘Watch On’ icon is selected or if a playback time of the registered program arrives) at operation 1111, the control unit 300 may request the external display device 190 to power on and transmit the channel information on the broadcast program to be played at operation 1113. The control unit 300 may process the broadcast signal received by the broadcast receiver 350 and control the display unit 330 to display the broadcast program. That is, in the case that the electronic device 100 is provided with the broadcast receiver 350, the electronic device 100 is capable of playing the broadcast signal without driving the external display device 190. If a command for driving the external display device 190 is input by the user in the state that the broadcast signal received by the broadcast receiver 350 is being played on the display unit 330, the control unit 300 may detect this at operation 1111 and control the external display unit 190 to play the broadcast signal at operation 1113. The external display device plays the broadcast signal under the control of the electronic device 100. If the control unit 300 does not detect the broadcast signal received being played, the control unit 300 may perform a corresponding function at operation 1181.

FIGS. 12A and 12B show a case of controlling the external device 190 to play the broadcast signal in the state that the electronic device 100 may play the broadcast signal. That is, in order to control the external display device 190 to play the program as shown in part 1210 of FIG. 12A, the user selects ‘Watch On’ icon on the program information screen or selects a button 1215 for activating the external display device 190 in the state of playing the broadcast program on the display unit 330. The control unit 220 scans around for the external display device as shown in part 1220. If only the external display device is found, the control unit may control the external display device to play the broadcast program as shown in part 1230 of FIG. 12B. The found external display device receives and plays the broadcast program as shown in part 1240 of FIG. 12B. Otherwise, if a plurality of external display devices are found, the control unit 330 may display a list of the found external display devices as shown in part 1250 of FIG. 12A and, if the user select an external display device from the list, the control unit 330 may control the selected external display device to play the broadcast program as shown in part 1240 of FIG. 12B. However, if no external display device is found at 1260, the control unit 330 may control to present a notification message and end the control of the broadcast playback on the external display device. In this case, the control unit 300 may control the broadcast receiver 350 and the display unit 330 to play the broadcast program 1290.

When the external display device 190 plays the broadcast program, the control unit 300 may control the display unit 330 to display buttons of menus associated with the broadcast program. In the case that the broadcast program is one of a series of episodes, the associated menus may include episode selection menus capable of selecting previously broadcast episodes, a note menu for receiving input of information, and supplementary information menu for displaying the supplementary information on the program. If the user selects an interoperation menu button by means of the input unit 340 in the state of playing the program, the control unit 300 may detect this at operation 1115 and display the menu buttons for providing interoperation services of the corresponding program at operation 1117. If the control unit 300 does not detect selection of the interoperation menu button at operation 1115, the control unit 300 may determine if processing should end at operation 1179.

If the currently playing broadcast program is one of a series of episodes and if the user selects an associated broadcast selection menu is selected, the control unit 300 may detect this at operation 1131 and display related broadcast programs (e.g. previously broadcast episodes of a serial drama) at operation 1133. If one of the related broadcast programs is selected, the control unit 300 may detect this at operation 1135 and control the external display device 190 to request recording the broadcast program and download the related broadcast program from the broadcast server 120 at operation 1137. The control unit 300 may plays the downloaded program at operation 1139. The related broadcast program may be played by the electronic device 100 or by the external display device 190. In the case that the external display device 190 plays the broadcast program, the control unit 300 may transfer the downloaded broadcast program to the external device 190 through the second communication unit 370, and the external display device 190 may store the broadcast program received from the electronic device 100 while playing the related previous broadcast program (previous episode). If the related broadcast program playback has completed, the control unit may detect this at operation 1141 and processes the recorded broadcast program at operation 1143. The control unit 300 may request the external display device 190 to transmit the recorded program and store the received program or control the external display device 190 to play the recorded program without request for transmission of the recorded program.

It is assumed that the broadcast program corresponding to the program information as shown in part 1270 of FIG. 12C is one of a series of episodes. In the state that the external display device 190 plays the broadcast program 1213, the user may select a previous episode of the broadcast program. If the user selects a menu in the state that the external display device 190 plays the broadcast program, the control unit 300 may display a list of the episodes broadcast before the current episode as denoted by reference number 1223 in display 1280. If an episode is selected from the list, the control unit 300 may control to record the current episode while playing the selected episode. The selected episode (e.g. episode broadcast before the date of the current broadcast episode) may be played on the electronic device 100 which may transmit the broadcast signal of the received previous episode to the external display device 190 through the second communication unit 390 such that the external display device 190 plays the received broadcast signal.

As described above, if the broadcast program is a serial drama which consists of a plurality of episodes, it is possible to select an episode selection menu in the state that the drama is being played on the external display device 190 or the electronic device 100. The electronic device 100 may drive the external display device 190 and controls the external display device 190 to play the broad signal, and the external display device 190 and the electronic device 100 may play different episodes simultaneously. For example, the electronic device 100 may play Episode 1 while the external display device plays Episode 2. The electronic device 100 may control the external display device 190 to record Episode 2.

If a note menu is selected in the state that the interoperation service menu items are presented, the control unit 300 may detect this at operation 1151 and control the external display device 190 to record the playing program and transition the operation mode of the electronic device 100 to the note mode at operation 1153. The electronic device 100 may receive the broadcast program signal through the broadcast receiver 350 and stored the received signal. The user may make a note by means of the input unit 340 of the electronic device 100 while viewing the broadcast program being played by the external display device 190. The control unit 300 may detect the input of the memo at operation 1157 and store the memo in alignment with the program playback timeline at operation 1159. If the note mode ends, the control unit 300 may detect this at operation 1161 and store the recorded broadcast program and notes at operation 1163. The control unit 300 may store the memos as combined with or separated from the broadcast program. In the case that the broadcast program is not recorded at the electronic device 100, the control unit 300 may control the external display device 190 to receives and record the broadcast program. When playing the recorded program, the control unit 300 may display the memo as synthesized with the broadcast program or separated from the broadcast program by splitting the screen.

In the case that the broadcast program is an education broadcast program, the electronic device 100 may activate the note menu. In this case, the user may write a note while viewing the education program being played on the external display device 190.

If the user selects the supplementary information menu in the state that the interoperation service menu is presented, the control unit 300 may detect selection of the broadcast program at operation 1171 and display the broadcast program information at operation 1173. If a certain supplementary information item is selected, the control unit 300 may detect this at operation 1175 and display the corresponding supplementary information of the program at operation 1177. If a request for terminating the display of the supplementary information is detected, the control unit 300 may detect this at operation 1161 and end the display of the supplementary information.

In a case of a sports event broadcast, the control unit 300 may control the external display device 190 to play the sports broadcast. If the user selects the supplementary information menu, the control unit 300 may control the display unit 330 to display the program information on the sports broadcast being played on the external display unit 190. In this case, the program information may include team, coach, players, and event, etc. If the user selects a certain information item (e.g. certain player), the control unit 300 may download and displays detailed information corresponding to the selected item. In the case of a movie and/or drama, control unit 300 may control the electronic device to search for the information on the characters appearing in the broadcast program played on the external display device 190 and/or relationship among the characters and display the found information in detail.

As described above, the broadcast playback control apparatus and method of the present disclosure is capable of taking advantages of various devices constituting a display system so as to improve device usability and user satisfaction.

The broadcast playback control apparatus and method of the present disclosure is capable of allowing the user to reserve a broadcast program as a schedule by means of the electronic device using the broadcast program information and the electronic device to control the external display device to display the reserved broadcast program in the system including the electronic device and the electronic display device. The electronic device may associates an application (e.g. S planner) and VOD (On Demand) in reserving the broadcast program so as to register the broadcast program as a reserved schedule while viewing the broadcast program information.

The electronic device may control the external display device to display the broadcast program, receive and store the program-related information input to the electronic device in association with the program, and allow for checking the program information through the electronic device.

Various aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), CD-ROMs, magnetic tapes, floppy disks, and optical data storage devices. The non-transitory computer readable recording medium can also be distributed over network coupled computer systems so that the computer readable code is stored and executed in a distributed fashion. Also, functional programs, code, and code segments for accomplishing the present disclosure can be easily construed by programmers skilled in the art to which the present disclosure pertains.

At this point it should be noted that various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present disclosure can be easily construed by programmers skilled in the art to which the present disclosure pertains.

The specification and drawings are to be regarded in an illustrative rather than a restrictive sense in order to help understand the present disclosure. It is obvious to those skilled in the art that various modifications and changes can be made thereto without departing from the broader spirit and scope of the disclosure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A broadcast playback control method of an electronic device, the method comprising:
displaying program information including a schedule registration icon;
scheduling, when the schedule registration icon is selected, a broadcast program slotted to play at a broadcast time included in the program information; and
controlling playback of the registered program at the broadcast time.

2. The method of claim 1, wherein the controlling of the playback comprises:
driving an external display device;
transmitting the program information to the external display device; and
controlling the external display device to play the registered broadcast program.

3. The method of claim 2, wherein the scheduling of the broadcast program comprises:
displaying, when the schedule registration icon is selected, a calendar; and
registering the broadcast program at the date corresponding to the broadcast time of the broadcast program as a scheduled item on the calendar.

4. The method of claim 3, further comprising displaying, when the scheduled item is selected, detailed information on the broadcast program.

5. The method of claim 3, wherein the registering of the broadcast program comprises:
displaying, when the broadcast program is a pay program, the program information including a purchase icon;
purchasing, when the purchase icon, the broadcast program;
displaying, when the broadcast program is purchased successfully, the calendar; and
registering the broadcast program at the date corresponding to the broadcast time of the broadcast program as the schedule item on the calendar.

6. The method of claim 3, further comprising:
transmitting the information on the broadcast program registered as the scheduled item to a broadcast server;
displaying, when the program information transmitted by the broadcast server is received, the calendar; and
registering the broadcast program at the date corresponding to the broadcast time of the broadcast program as the scheduled item on the calendar.

7. The method of claim 3, further comprising:
marking, when the broadcast program is not played at the scheduled time, the broadcast program as a missing program; and
registering, when the mission program has a rebroadcast time, the broadcast program at the date corresponding to the rebroadcast time as the scheduled item.

8. A broadcast playback control method of an electronic device, the method comprising:
displaying program information including a schedule registration icon and a real time playback button;
scheduling, when the schedule registration icon is selected, a broadcast program slotted to play at a broadcast time included in the program information;
driving, when the real time playback button is selected, an external display device;
transmitting the program information to the external display device; and
controlling the external display device to play the registered broadcast program.

9. The method of claim 8, further comprising:
driving, when the broadcast time arrives, the external display device;
transmitting the program information to the external display device; and
controlling the external display device to play the registered broadcast program.

10. The method of claim 9, wherein the controlling of the external display device comprises:
displaying interoperation service menu items;
controlling, when one of the service menu items is selected, the external display device to play the broadcast program; and
processing at least one of another broadcast program and program information related to the broadcast program which is playing.

11. The method of claim 10, wherein the interoperation service menu items include a related broadcast program selection menu item, and the controlling of the external display device comprises instructing, when the related broadcast program selection menus item is selected, the external display device to record the broadcast program which is currently playing and receives and plays the related broadcast program.

12. The method of claim 10, wherein the interoperation service menu items comprise a note menu item, and the controlling of the external display device comprises receiving, when the note menu item is selected, input of note information, aligning the note information with playing time of the recorded broadcast program, and storing, when the note menu ends, the note information aligned with the playing time of the recorded broadcast program.

13. The method of claim 10, wherein the interoperation service menu items comprise a supplementary information menu item, and the controlling of the external display device comprises receiving and displaying, when the supplementary information menu item is selected, supplementary information on the broadcast program being played currently.

14. A broadcast program processing method of a broadcast server system, the method comprising:
receiving program information on a broadcast program selected by a user from an electronic device;
analyzing the received program information to check broadcast program pattern;
selecting user favorite broadcast program based on the analysis result; and
transmitting the broadcast information on selected broadcast program to the electronic device registering the received broadcast program as a schedule item.

15. A broadcast playback control apparatus of an electronic device, the apparatus comprising:
a communication unit configured to receive a broadcast program;
a display unit configured to display the program information including a schedule registration icon and a calendar for registering the broadcast program with the program information;
a storage unit configured to store the program information as a scheduled item of the calendar; and
a control unit configured to display the program information including the schedule registration icon, schedule, and, when the schedule registration icon is selected, the broadcast program slotted to play at a broadcast time included in the program information, and control playback of the registered program at the broadcast time.

16. The apparatus of claim 15, further comprising a short range communication unit configured to establish a connection link with an external display device, wherein the control unit drives the external display device, transmits the program information to the external display device, and controls the external display device to play the registered broadcast program

17. The apparatus of claim 16, wherein the control unit controls the display unit to display, when the schedule registration icon is selected, a calendar and registers the broadcast program at the date corresponding to the broadcast time of the broadcast program as a scheduled item on the calendar.

18. The apparatus of claim 17, wherein the program information includes, when the broadcast program is a pay program, a purchase icon, and the control unit controls, when the purchase icon is selected, the display unit to display the calendar and registers date information and broadcast information as the scheduled item on the calendar.

19. The apparatus of claim 18, wherein the control unit transmits the program information on the program registered as scheduled item to a broadcast server and registers, when the broadcast program is received from the broadcast server, the broadcast program as the scheduled item on the calendar.

20. The apparatus of claim 16, wherein the control unit controls, when the external display device plays the broadcast program, the display unit to display interoperation service menu items and processes, when one of the service menu items is selected, at least one of another broadcast program and program information related to the broadcast program which is being played, being played on the external display device.

21. A non-transitory computer-readable storage medium storing instructions that, when executed, cause at least one processor to perform the method of claim 1.
